(19) United States
(12) Patent Application Publication
(10) Pub. No.: US 2004/0205457 A1
(43) Pub. Date: Oct. 14, 2004

(54) Automatically summarising topics in a collection of electronic documents

(75) Inventors: Graham Bent, Bitterne (GB); Karin Schmidt, Wien (AT)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/998,126

(22) Filed: Oct. 31, 2001

(51) Int. Cl. G06F 17/24

(52) U.S. Cl. 715/500; 707/6

(57) ABSTRACT

Automatically detecting and summarising at least one topic in at least one document of a document set, whereby each document has a plurality of terms and a plurality of sentences comprising a plurality of terms. Furthermore, the plurality of terms and the plurality of sentences are represented as a plurality of vectors in a two-dimensional space. Firstly, the documents are pre-processed to extract a plurality of significant terms and to create a plurality of basic terms. Next, the documents and the basic terms are formatted. The basic terms and sentences are reduced and then utilised to create a matrix. This matrix is then used to correlate the basic terms. A two-dimensional co-ordinate associated with each of the correlated basic terms is transformed to an n-dimensional coordinate. Next, the reduced sentence vectors are clustered in the n-dimensional space. Finally, to summarise topics, magnitudes of the reduced sentence vectors are utilised.

### BACKGROUND OF THE INVENTION

1. Field of the Invention

The present invention relates to automatic discovery and summarisation of topics in a collection of electronic documents.

2. Description of the Related Art

The amount of electronically stored data, specifically textual documents, available to users is growing steadily. For a user, the task of traversing electronic information can be very difficult and time-consuming. Furthermore, since a textual document has limited structure, it is often laborious for a user to find a relevant piece of information, as the relevant information is often “buried”.

In an Internet environment, one method of solving this problem is the use of information retrieval techniques, such as search engines, to allow a user to search for documents that match his/her interests. For example, a user may require information about a certain “topic” (or theme) of information, such as, “birds”. A user can utilise a search engine to carry out a search for documents related to this topic, whereby the search engine searches through a web index in order to help locate information by keyword for example.

Once the search has completed, the user will receive a vast resultant collection of documents. The results are typically displayed to the user as linearly organized, single document summaries, also known as a “hit list”. The hit list comprises of document titles and/or brief descriptions, which may be prepared by hand or automatically. It is generally sorted in the order of the documents' relevance to the query. Examples may be found at http://yahoo.com and http://altavista.com, on the World Wide Web.

However, whilst some documents may describe a single topic, in most cases, a document comprise multiple topics (e.g. birds, pigs, cows). Furthermore, information on any one topic may be distributed across multiple documents. Therefore, a user requiring information about birds only, will have to pore over one or more of the collection of documents received from the search, often having to read through irrelevant material (related to pigs and cows for example), before finding information related to the relevant topic of birds. Additionally, the hit list shows the degree of relevance of each document to the query but it fails to show how the documents are related to one another.

Clustering techniques can also be used to give the user an overview of a set of documents. A typical clustering algorithm divides documents into groups (clusters) so that the documents in a cluster are similar to one another and are less similar to documents in other clusters, based on some similarity measurement. Each cluster can have a cluster description, which is typically one or more words or phrases frequently used in the cluster.

Although a clustering program can be used to show which documents discuss similar topics, in general, a clustering program does not output explanations of each cluster (cluster labels) or, if it does, it still does not provide enough information for the user to understand the document set.

For instance, U.S. Pat. No. 5,857,179 describes a computer method and apparatus for clustering documents and automatic generation of cluster keywords. An initial document by term matrix is formed, each document being represented by a respective M dimensional vector, where M represents the number of terms or words in a predetermined domain of documents. The dimensionality of the initial matrix is reduced to form resultant vectors of the documents. The resultant vectors are then clustered such that correlated documents are grouped into respective clusters. For each cluster, the terms having greatest impact on the documents in that cluster are identified. The identified terms represent key words of each document in that cluster. Further, the identified terms form a cluster summary indicative of the documents in that cluster. This technique does not provide mechanism for identifying topics automatically, across multiple documents, and then summarising them.

Another method of information retrieval is text mining. This technology has the objective of extracting information from electronically stored textual based documents. The techniques of text mining currently include the automatic indexing of documents, extraction of key words and terms, grouping/clustering of similar documents, categorising of documents into pre-defined categories and document summarisation. However, current products, do not provide a mechanism for discovering and summarising topics within a corpus of documents.

U.S. patent application Ser. No. 09/517540 describes a system, method and computer program product to identify and describe one or more topics in one or more documents in a document set, a term set process creates a basic term set from the document set where the term set comprises one or more basic terms of one or more words in the document. A document vector process then creates a document vector for each document. The document vector has a document vector direction representing what the document is about. A topic vector process then creates one or more topic vectors from the document vectors. Each topic vector has a topic vector direction representing a topic in the document set. A topic term set process creates a topic term set for each topic vector that comprises one or more of the basic terms describing the topic represented by the topic vector. Each of the basic terms in the topic term set associated with the relevancy of the basic term. A topic-document relevance process creates a topic-document relevance for each topic vector and each document vector. The topic-document relevance representing the relevance of the document to the topic. A topic sentence set process creates a topic sentence set for each topic vector that comprises of one or more topic sentences that describe the topic represented by the topic vector. Each of the topic sentences is then associated with the relevance of the topic sentence to the topic represented by the topic vector.

Thus there is a need for a technique that discovers topics from within a collection of electronically stored documents and automatically extracts and summarises topics.

### SUMMARY OF THE INVENTION

According to a first aspect, the present invention provides a method of detecting and summarising at least one topic in at least one document of a document set, each document in said document set having a plurality of terms and a plurality of sentences comprising said plurality of terms, whereby said plurality of terms and said plurality of sentences are represented as a plurality of vectors in a two-dimensional space, said method comprising the steps of: pre-processing said at least one document to extract a plurality of significant terms and to create a plurality of basic terms; in response to said pre-processing step, formatting said at least one document and said plurality of basic terms; in response to said formatting step, reducing said plurality of basic terms; reducing said plurality of sentences and creating a matrix of said reduced plurality of basic terms and said reduced plurality of sentences; utilising said matrix to correlate said plurality of basic terms; transforming a two-dimensional co-ordinate associated with each of said correlated plurality of basic terms to an “n”-dimensional co-ordinate; in response to said transforming step, clustering said reduced plurality of sentence vectors in said “n”-dimensional space, and associating magnitudes of said reduced plurality of sentence vectors with said at least one topic.

Preferably, the formatting step further comprises the step of producing a file comprising at least one term and an associated location within the at least one document of the at least one term. In a preferred embodiment, the creating a matrix step further comprises the steps of: reading the plurality of basic terms into a term vector; reading the file comprising at least one term into a document vector; utilising the term vector, the document vector and an associated threshold to reduce the plurality of basic terms; utilising the extracted plurality of significant terms to reduce the plurality of sentences, and reading the reduced plurality of sentences into a sentence vector.

Preferably, the correlated plurality of basic terms are transformed to hyper spherical co-ordinates. More preferably, end points associated with reduced plurality of sentence vectors lying in close proximity, are clustered. In the preferred embodiment, the clusters of the plurality of sentence vectors are linearly shaped.

Preferably, each of the clusters represents at least one topic and to improve results, in the preferred implementation, field weighting is carried out. In a preferred embodiment, a reduced sentence vector having a large associated magnitude, is associated with at least one topic.

According to a second aspect, the present invention provides a system for detecting and summarising at least one topic in at least one document of a document set, each document in said document set having a plurality of terms and a plurality of sentences comprising said plurality of terms, whereby said plurality of terms and said plurality of sentences are represented as a plurality of vectors in a two-dimensional space, said method comprising the steps of: means for pre-processing said at least one document to extract a plurality of significant terms and to create a plurality of basic terms; means, responsive to said pre-processing means, for formatting said at least one document and said plurality of basic terms; means, responsive to said formatting means, for reducing said plurality of basic terms; reducing said plurality of sentences and creating a matrix of said reduced plurality of basic terms and said reduced plurality of sentences; means for utilising said matrix to correlate said plurality of basic terms; means for transforming a two-dimensional co-ordinate associated with each of said correlated plurality of basic terms to an “n”-dimensional co-ordinate; means, responsive to said transforming means, for clustering said reduced plurality of sentence vectors in said “n”-dimensional space, and means for associating magnitudes of said reduced plurality of sentence vectors with said at least one topic.

According to a third aspect, the present invention provides a computer program product stored on a computer readable storage medium for, when run on a computer, instructing the computer to carry out the method as described above.

### BRIEF DESCRIPTION OF THE DRAWINGS

The present invention will now be described, by way of example only, with reference to preferred embodiments thereof, as illustrated in the following drawings:

FIG. 1 shows a client/server data processing system in which the present invention may be implemented;

FIG. 2 shows a small test document set, which may be utilised with the present invention;

FIG. 3 is a flow chart showing the operational steps involved in the present invention;

FIG. 4 shows the resultant file for the document set in FIG. 2, after a pre-processing tool has produced a normalised (canonical) form of each of the extracted terms, according to the present invention;

FIG. 5 shows a resultant document set, following the rewriting of the document set of FIG. 2, utilising only the extracted terms, according to the present invention;

FIG. 6 shows part of a hashtable for the document set of FIG. 2, according to the present invention;

FIG. 7 shows the term recognition process for one sentence of the document set of FIG. 2, according to the present invention;

FIG. 8 shows a flat file which can be used as input data for the “Intelligent Miner for text” tool, according to the present invention;

FIG. 9 shows a term vector, according to the present invention;

FIG. 10 shows a document vector, according to the present invention;

FIG. 11 shows a term vector with terms which occur at least twice, according to the present invention;

FIG. 12 shows a sentence vector, according to the present invention;

FIG. 13 shows the output file of a reduced term-sentence matrix, according to the present invention;

FIG. 14 shows a scatterplot of variables depicting a regression line that represents the linear relationship between the variables, according to the present invention;

FIG. 15 shows a scatterplot of component 1 against component 2, according to the present invention;

FIG. 16 shows the conversion from Cartesian co-ordinates to spherical co-ordinates, according to the present invention;

FIG. 17 shows a representation of an “n”-dimensional space, according to the present invention; and

FIG. 18 shows clustering in the spherical co-ordinate system, according to the present invention.

### DESCRIPTION OF PREFERRED EMBODIMENTS

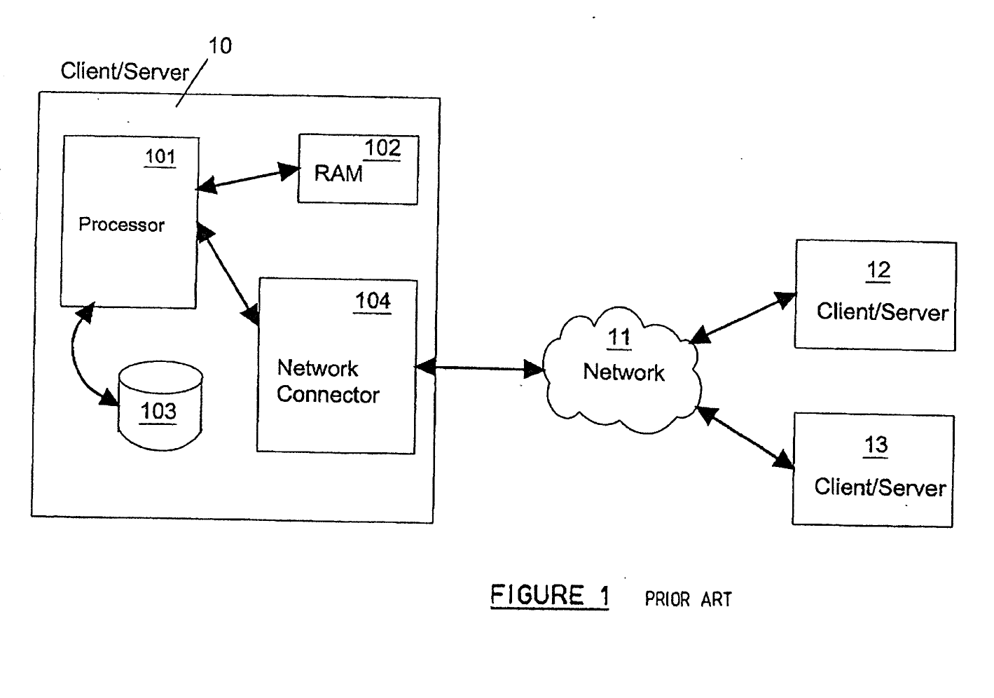

FIG. 1 is a block diagram of a data processing environment in which the preferred embodiment of the present invention can be advantageously applied. In FIG. 1, a client/server data processing apparatus (10) is connected to other client/server data processing apparatuses (12, 13) via a network (11), which could be, for example, the Internet. The client/servers (10, 12, 13) act in isolation or interact with each other, in the preferred embodiment, to carry out work, such as the definition and execution of a work flow graph, which may include compensation groups. The client/server (10) has a processor (101) for executing programs that control the operation of the client/server (10), a RAM volatile memory element (102), a non-volatile memory (103), and a network connector (104) for use in interfacing with the network (11) for communication with the other client/servers (12, 13).

Generally, the present invention provides a technique in which data mining techniques are used to automatically detect topics in a document set. “Data mining is the process of extracting previously unknown, valid and actionable information from large databases and then using the information to make crucial business decisions”, Cabena, P. et al.: Discovering Data Mining, Prentice Hall PTR, New Jersey, 1997, p.12. Preferably, the data mining tools “Intelligent Miner for Text” and “Intelligent Miner for Data” (Intelligent Miner is a trademark of IBM Corporation) from IBM Corporation, are utilised in the present invention.

Firstly, background details regarding the nature of documents will be discussed. Certain facts can be utilised to aid in the automatic detection of topics. For example, it is widely understood that certain words, such as “the” or “and”, are used frequently. Additionally, it is often the case that certain combinations of words appear repeatedly and furthermore, certain words always occur in the same order. Further inspection reveals that a word can occur in different forms. For example, substantives can have singular or plural form, verbs occur in different tenses etc.

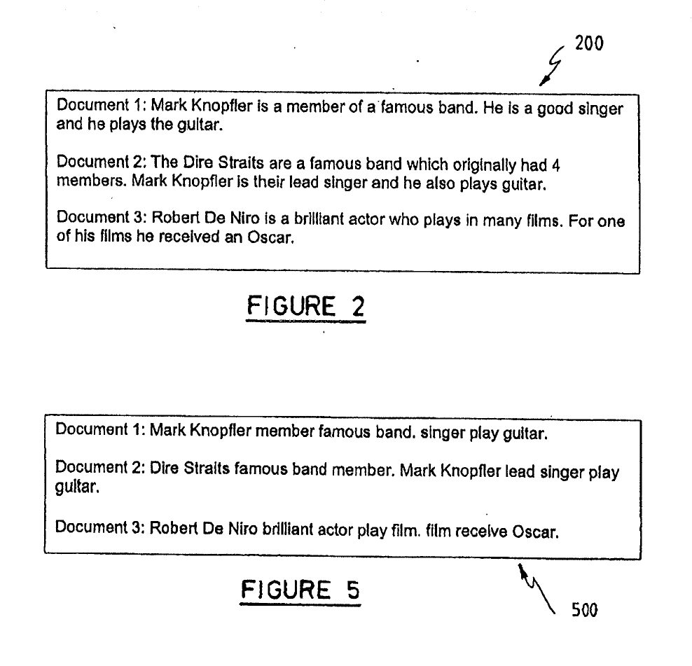

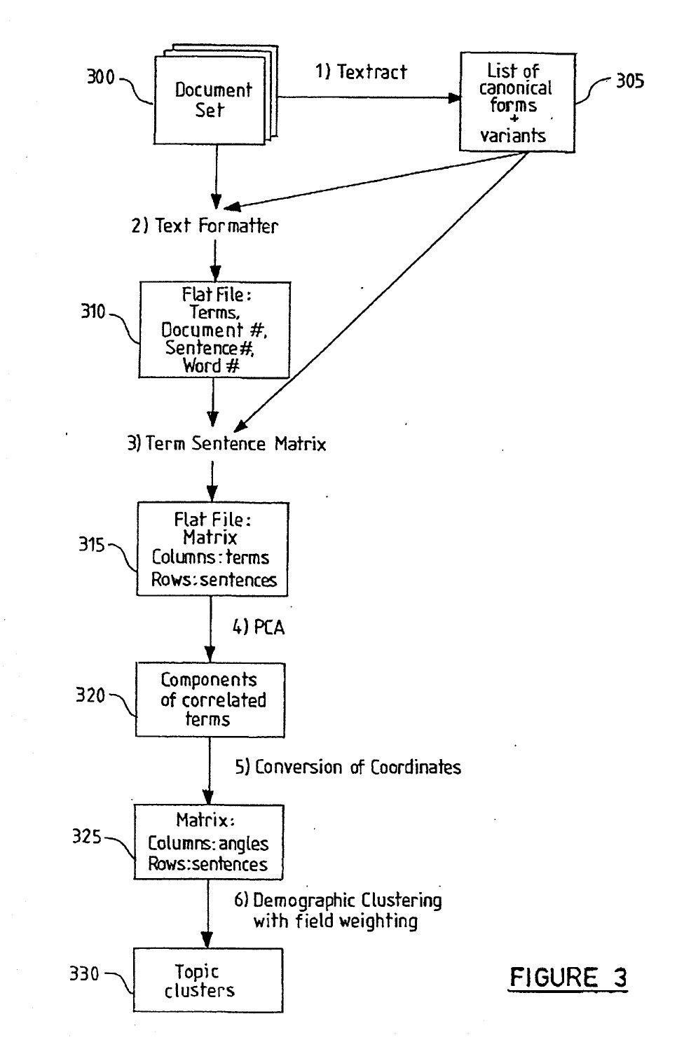

A small test document set (200) which is utilised as an example in this description, is shown in FIG. 2. FIG. 3 is a flow chart showing the operational steps involved in the present invention. The processes involved (indicated in FIG. 3 as numerals) will be described one stage at a time.

1. PRE-PROCESSING STEP

Firstly, the problems associated with the prior art will be discussed. Generally, with reference to the document set of FIG. 2, programs that are based on simple lexicographic comparison of words will not recognise “member” and “members” as the same word (which are in different forms) and therefore cannot link them. For this reason it is necessary to transform all words to a “basic format” or canonical form. Another difficulty is that programs usually “read” text documents word by word. Therefore, terms which are composed of several words are not regarded as an entity and furthermore, the individual words could have a different meaning from the entity. For example the words “Dire” and “Straits” are different in meaning to the entity “Dire Straits”, whereby the entity represents the name of a music band. For this reason it is important to recognise composed terms. Another problem is caused by words such as “the”, “and”, “a”, etc. These types of words occur in all documents, however in actual fact, the words contribute very little to a topic. Therefore it is reasonable to assume that the words could be removed with minimal impact on the information.

Preferably, to achieve the benefits of the present invention, data mining algorithms need to be utilised. Pre-processing of the textual data is required to format the data so that is suitable for mining algorithms to operate on. In standard text mining applications the problems described above are addressed by pre-processing the document set. An example of a tool that carries out pre-processing is the “Textract” tool, developed by IBM Research. The tool performs the textual pre-processing in the “Intelligent Miner for Text” product. This pre-processing step will now be described in more detail.

“Textract” comprises a series of algorithms that can identify names of people (NAME), organisations (ORG) and places (PLACE); abbreviations; technical terms (UTERM) and special single words (UWORD). The module that identifies names, “Nominator”, looks for sequences of capitalised words and selected prepositions in the document set and then considers them as candidates for names. The technical term extractor, “Terminator”, scans the document set for sequences of words which show a certain grammatical structure and which occur at least twice. Technical terms usually have a form that can be described by a regular expression:

((A|N)+|((A|N)*(NP)?)(A|N)*)N

whereby “A” is an adjective, “N” is a noun and “P” is a preposition. The symbols have the following meaning:

| Either the preceding or the successive item.

? The preceding item is optional and matched at most once.

*The preceding item will be matched zero or more times.

+ The preceding item will be matched one or more times.

In summary, a technical term is therefore either a multi-word noun phrase, consisting of a sequence of nouns and/or adjectives, ending in a noun, or two such strings joined by a single preposition.

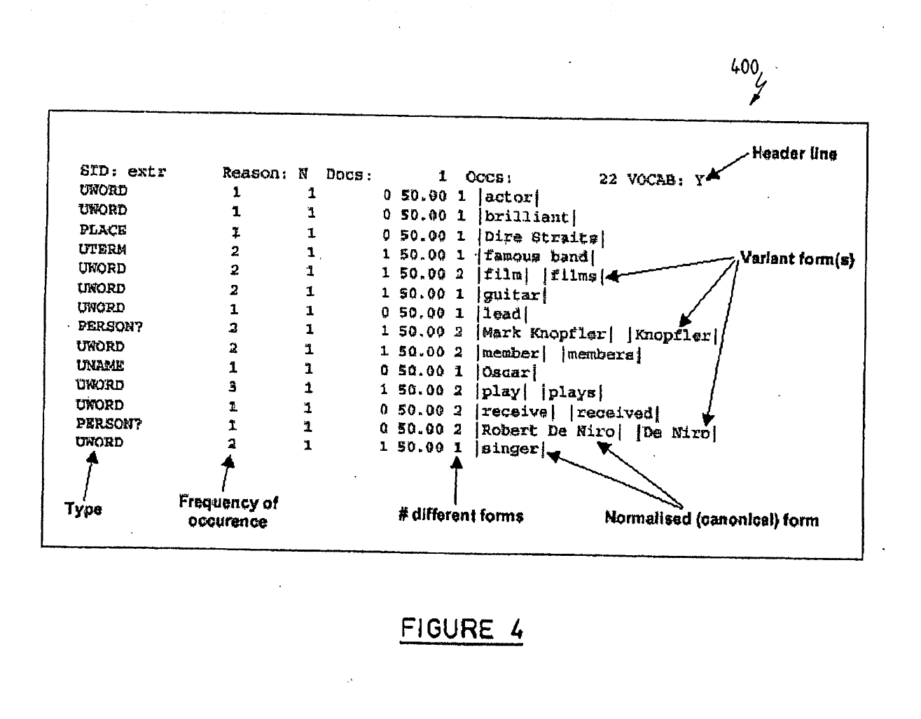

“Textract” also performs other tasks, such as filtering stop-words (e.g. “and”, “it”, “a” etc.) on the basis of a predefined list. Additionally, the tool provides a normalised (canonical) form to each of the extracted terms, whereby a term can be one of a single word, a name, an abbreviation or a technical term. The latter feature is realised by means of several dictionaries. Referring to FIG. 3, “Textract” creates a vocabulary (305) of canonical forms and their variants with statistical information about their distribution across the document set. FIG. 4 shows the resultant file (400) for the example document set, detailing the header, category of each significant term (shown as “TYPE”, e.g. “PERSON”, “PLACE” etc.), the frequency of occurrence, the number of forms of the same word, the normalised form and the variant form(s). FIG. 5 shows the resultant document set (500), following a re-writing utilising only the extracted terms.

To summarise, the preparation of text documents with the “Textract” tool accomplishes three important results:

1. The combination of single words which belong together as an entity;

2. The normalisation of words; and

3. The reduction of words.

2. TEXT FORMATTER

The process of transforming the text documents so that the “Intelligent Miner for Text” tool can utilise these documents as input data will now be described. The “Intelligent Miner for Text” tool expects input data to be stored in database tables/views or as flat files that show a tabular structure. Therefore, further preparation of the documents is necessary, in order for the “Intelligent Miner for Text” tool to process them.

A prior art simple stand-alone Java (Java is a registered trademark of Sun Microsystems Inc.) application called “TextFormatter” carries out the function of further preparation. Generally, referring to FIG. 3, “TextFormatter” reads both the textual document (300) in the document set and the term list (305) generated in stage 1. It then creates a comma separated file (310) which holds columns of terms, and the location of those terms within the document set, that is, the document number, the sentence number and the word number.

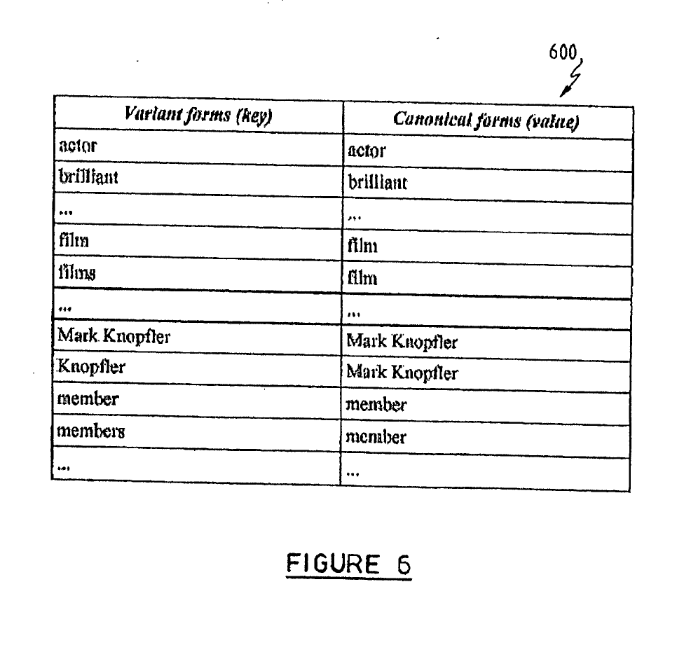

The detailed process carried out by “TextFormatter” will now be described. Firstly, the list of canonical forms and variants is read into a hashtable. Each variant and the appropriate canonical form have an associated entry, whereby the variant is the key and the canonical form the value. Each canonical form has an associated entry as well, where it is used as key and as a value. FIG. 6 shows part of an example hashtable (600).

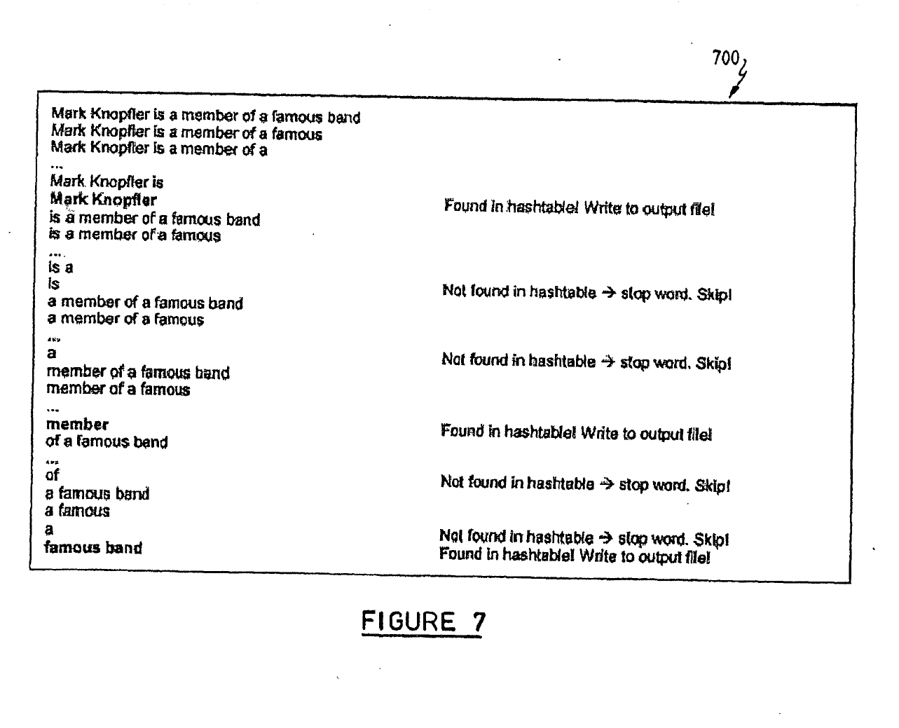

Next, the text from the document is read in and tokenised into sentences. Sentences again are tokenised into words. Now the sentences have to be checked for terms that have an entry in the hashtable. Since it is possible that words which are part of a composed term occur as single words as well, it is necessary to check a sentence “backwards”. That is, firstly the hashtable is searched for a test string which consists of the whole sentence. When no valid entry is found one word is removed from the end of the test string and the hashtable is searched again. This is repeated until either a valid entry was found (then the canonical form of the term and its document, sentence and word number are written to the output file) or only a single word remains (→stop word, it is not written to the output file). In either case, the word(s) are removed from the beginning of the sentence, the test string is rebuilt from the remaining sentence and the whole procedure starts again until the sentence is “empty”. This is repeated for every sentence in the document. FIG. 7 shows the term recognition process for one sentence. To summarise, the output flat file can now be used as input data for “Intelligent Miner for Text” and an example file (800) is shown in FIG. 8.

3. TERM SENTENCE MATRIX

The creation of a prior art “term-sentence matrix” is required because to apply the technique of demographic clustering (stage 6 in FIG. 3), the clustering technique expects a table of variables and records. That is, a text document has to be transformed into a table, whereby the words are the variables (columns) and the sentences the records (rows). This table is referred to as a term-sentence matrix in this description.

To create the matrix a prior art, simple stand-alone Java application called “TermSentenceMatrix” is preferably utilised. As shown in FIG. 3, “TermSentenceMatrix” requires two input files, namely, a flat file (310) which was generated by “TextFormatter” and a term list (305), which was created by “Textract”.

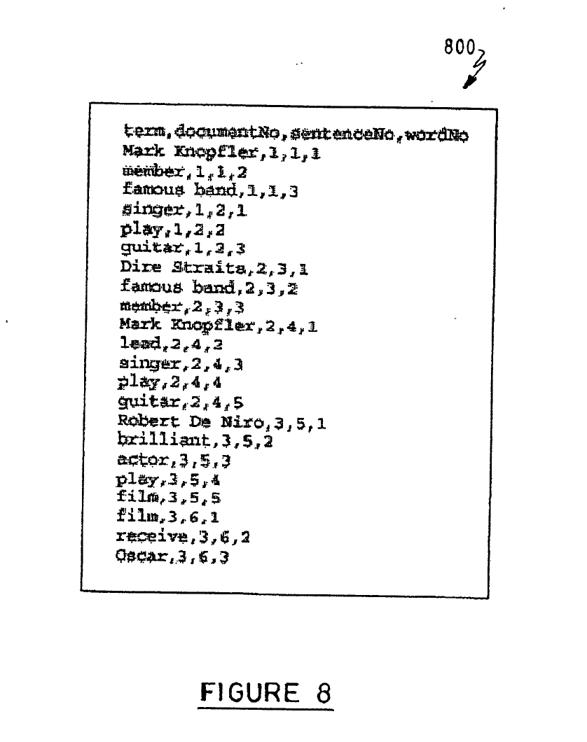

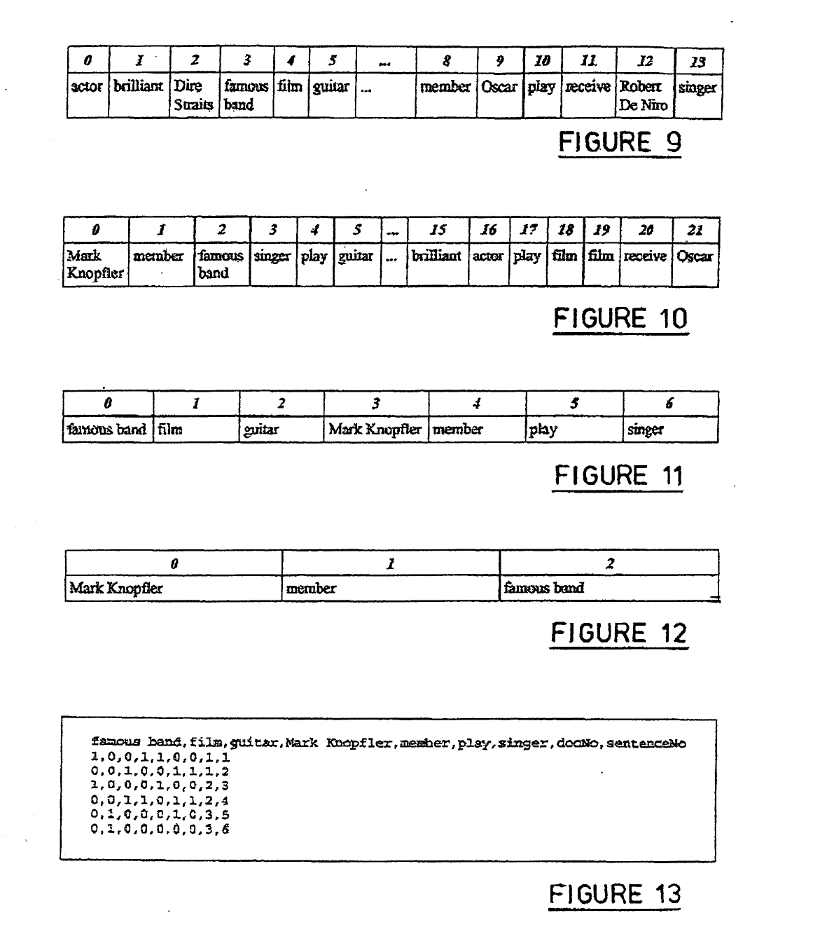

The technical steps carried out by “TermSentenceMatrix” will now be described. Firstly, “TermSentenceMatrix” opens the term list (305) of canonical forms and variants and reads the list (305) line by line—the canonical forms are used to define the columns of a term-sentence matrix. The terms in their canonical forms are read into a term vector (whereby each row of the term-sentence matrix represents a term vector) one by one, until the end of the file is reached. In the case of the demonstration document set, the list (305) contains 14 canonical forms and therefore, the term vector has a length of 14 (0-13). A term vector is shown in FIG. 9.

To be admitted as a column of the term-sentence matrix, a term must occur in the sentences of the document set more often than a minimum frequency, whereby a user or administrator may determine the minimum frequency. For instance, it is illogical to add terms to the matrix that occur only once, as the objective is to find clusters of sentences which have terms in common. In the following examples a minimum frequency of two was chosen. Preferably, if larger document sets are utilised, a user or administrator sets a higher value for the threshold.

To calculate the actual frequency of occurrence of terms, the flat file (310) of terms, which was generated by “TextFormatter”, is preferably opened by “TermSentenceMatrix” and the file is read line by line. “TermSentenceMatrix” reads the column of terms into another vector named document vector. As shown in FIG. 8, the documents in the demonstration document set comprise 22 terms. Therefore, the document vector as shown in FIG. 10, has a length of 22 (0-21).

Next, the document vector is searched for all occurrences of term #1 (“actor”) of the term vector. If the term occurs at least as often as the specified minimum frequency, it remains in the term vector and if the term occurs less often, it is removed. Since “actor” occurs only once in the document vector, the term is deleted from the head of the term vector. The term vector has now a length of 13 (0-12) as the first element was removed.

The next two terms (“brilliant”, “Dire Straits”) occur only once and are therefore removed from the term vector as well. Since “famous band” is the first term which occurs twice in the document vector, it remains in the term vector. This procedure is repeated for all terms in the term vector. FIG. 11 shows a term vector with terms which occur at least twice. Here, only 7 (0-6) terms remain in the term vector.

After the term vector is reduced, the computation of the term-sentence matrix begins. To compute the term-sentence matrix, sentence by sentence of the document set is searched for occurrences of terms that are within the reduced term vector. Firstly, as shown in FIG. 12, sentence #1 is read and written into a sentence vector. Since sentence #1 contains 3 terms, the sentence vector length is 3 (0-2). The sentence vector is searched for all occurrences of term #1 of the term vector and the frequency is written to the output file and an example of the output term-sentence matrix file is shown in FIG. 13. After the first sentence is processed, the sentence vector is cleared and the sentence #2 is read into the sentence vector etc. The process is repeated for all terms in the term vector and for all sentences in the document set.

The output file can now be used as input data for the “Intelligent Miner for text” tool. In addition to the terms, two columns, “docNo” (document number) and “sentenceNo” (sentence number), are included in the file.

Each row of the term-sentence matrix is a term vector that represents a separate sentence from the set of documents being analysed. If similar vectors can be grouped together (that is, clustered), then it is assumed that the associated sentence is related to the same topic. However as the number of sentences increases, the number of terms to be considered also increases. Therefore, the number of components of the vector that have a zero entry (meaning that the term is not present in the sentence) also increases. In other words, as a document set gets larger, it is likely that there will be more terms which do NOT occur in a sentence, than terms that do occur.

To address this issue, there is a need to reduce the dimensionality of the problem from the m terms to a much smaller number that accounts for the similarity between words used in different sentences.

4. PRINCIPAL COMPONENT ANALYSIS

In data mining one prior art solution to the equivalent problem described above, is to reduce the dimensionality by putting together fields that are highly correlated and the technique used is principal component analysis (PCA).

PCA is a method to detect structure in the relationship of variables and to reduce the number of variables. PCA is one of the statistical functions provided by the “Intelligent Miner for Text” tool. The basic idea of PCA is to detect correlated variables and combine them into a single variable (also known as a component) (320).

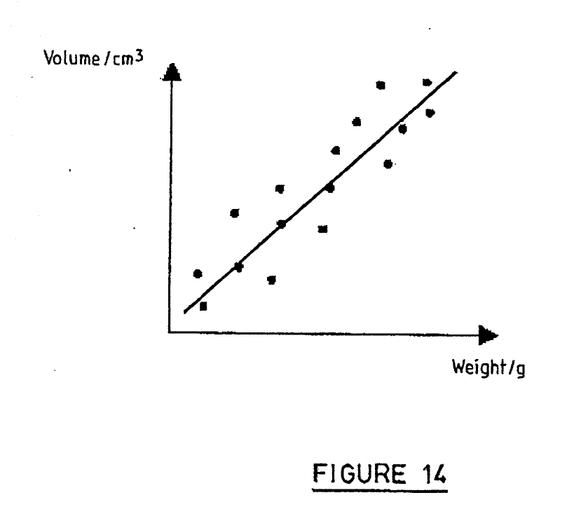

For example, in the case of a study about different varieties of tomatoes, among other variables, the volume and the weight of the tomatoes are measured. It is obvious that the two variables are highly correlated and consequently there is some redundancy in using both variables. FIG. 14 shows a scatterplot of the variables depicting a regression line that represents the linear relationship between the variables.

To resolve the redundancy problem, the original variables can be replaced by a new variable that approximates the regression line without losing much information. In other words the two variables are reduced to one component, which is a linear combination of the original variables. The regression line is placed so that the variance along the direction of the “new” variable (component) is maximised, while the variance orthogonal to the new variable is minimised.

The same principle can be extended to multiple variables. After the first line is found along which the variance is maximal, there remains some residual variance around this line. Using the regression line as the principal axis, another line that maximises the residual variance can be defined and so on. Because each consecutive component is defined to maximise the variability that is not captured by the preceding component, the components are independent of (or orthogonal to) each other in respect to their description of the variance.

In the preferred implementation, the calculation of the principal components for the term sentence matrix is performed using the PCA function of the “Intelligent Miner for Text” tool. The mathematical technique used to perform this involves the calculation of the co-variance matrix of the term-sentence matrix. This matrix is then diagonalized, to find a set of orthogonal components that maximise the variability, resulting in an “m” by “m” matrix, whereby “m” is the number of terms from the term-sentence matrix. The off-diagonal elements of this matrix are all zero and the diagonal elements of the matrix are the eigenvalues (whereby eigenvalues correspond to the variance of the components) of the corresponding eigenvectors (components). The eigenvalues measure the variance along each of the regression lines that are defined by the corresponding eigenvectors of the diagonalized correlation matrix. The eigenvectors are expressed as a linear combination of the original extracted terms and are also known as the principal components of the term co-variance matrix.

The first principal component is the eigenvector with the largest eigenvalue. This corresponds to the regression line described above. The eigenvectors are ordered according to the value of the corresponding eigenvalue, beginning with the highest eigenvalue. The eigenvalues are then cumulatively summed. The cumulative sum, as each eigenvalue is added to the summation, represents the fraction of the total variance that is accounted for by using the corresponding number of eigenvectors. Typically the number of eigenvectors (principal components) is selected to account for 90% of the total variance.

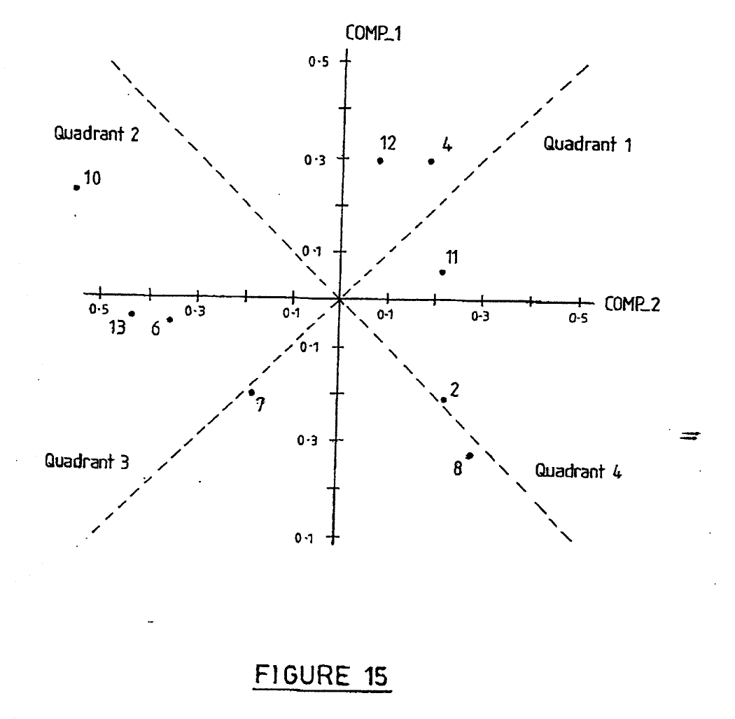

FIG. 15 shows results obtained in the preferred implementation, namely, a scatterplot of component 1 against component 2, whereby the points depict the original variables (terms). It should be understood that not all of the points are shown. The labels are as follows:

0 actor

1 brilliant

2 Dire Straits

3 famous band

4 film

5 guitar

6 lead

7 Mark Knopfler

8 member

9 Oscar

10 play

11 receive

12 Robert De Niro

13 singer

If a point has a high co-ordinate value on an axis and lies in close proximity to it, there is a distinct relationship between the component and the variable. The two-dimensional chart shows how the input data is structured. The vocabulary that is exclusive for the “Robert De Niro” topic (actor, brilliant, film, Oscar, receive, Robert De Niro) can be found in the first quadrant (some dots lie on top of each other). The “Dire Straits” topic (Dire Straits, famous band, guitar, lead, Mark Knopfler, member) is located in quadrants three and four. The word “play”, which occurs in both documents, is in quadrant 2.

To summarise, by utilising PCA, the terms are reduced to a set of orthogonal components (eignevectors), which are a linear combination of the original extracted terms.

5. CONVERSION OF CO-ORDINATES

A Cartesian co-ordinate frame is constructed from the reduced set of eigenvectors, which form the axes of the new co-ordinate frame. Since the number of principal components is now less (usually significantly less) than the number of terms in the term-sentence matrix, the number of dimensions of the new co-ordinate frame (say “n”) is also significantly less (“n”-dimensional).

Since the principal components are a linear combination of the original terms, the original terms can be represented as term-vectors (points) in the new co-ordinate system. Similarly, since sentences can be represented as a linear combination of the term vectors, the sentences can also be represented as sentence vectors in the new co-ordinate system. A vector is determined by its length (distance from its origin) and its direction (where it points to). This can be expressed in two different ways:

a. By using the x-y co-ordinates. For each axis there is a value that determines the distance on this axis from the origin of the co-ordinate system. All values together mark the end point of the vector.

b. By using angles and length. A vector forms an angle with each axis. All these angles together determine the direction and the length determines the distance from the origin of the co-ordinate system.

The transformation into the new co-ordinate system has the effect that sentences relating to the same topic are found to be represented by vectors that all point in a similar direction. Furthermore, sentences that are most descriptive of the topic have the largest magnitude. Thus, if the end point of each vector is used to represent a point in the transformed co-ordinate system, then topics are represented by “linear” clusters in the “n”-dimensional space. This results in topics being represented by “n”-dimensional linear clusters that contain these points.

To automatically extract these clusters it is necessary to use a clustering algorithm as shown in stage 6 of FIG. 3. In general clustering algorithms tend to produce “spherical” clusters (which in an “n”-dimensional co-ordinate system is an “n”-dimensional sphere or hyper sphere). To overcome this tendency it is necessary to perform a further co-ordinate transformation such that the clustering is performed in a spherical co-ordinate system rather than the Cartesian system and the further co-ordinate transformation will now be described.

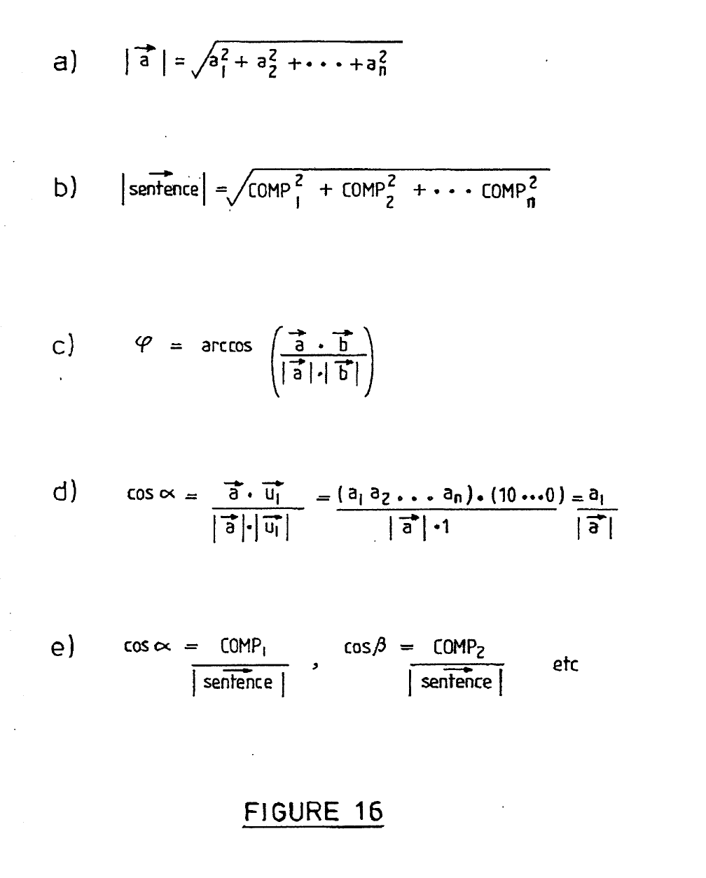

A vector is unequivocally determined by its length and its direction. The length of a vector (see (a)) is calculated as shown in FIG. 16. Consequently, the equation for the length of a sentence vector (see (b)) is also shown. The direction of a vector is determined by the angles, which it forms with the axes of a co-ordinate system. The axes can be regarded as vectors and therefore the angles between a vector and the axes can be calculated by means of the scalar (dot) product (see (c)) as shown, whereby “a” is the vector and “b” successively each of the axes. For each axis, its unit vector can be inserted and the equation is simplified (see (d)) as shown. Consequently, the equations for the angles of a sentence vector (see (e)) are shown.

6. CLUSTERING

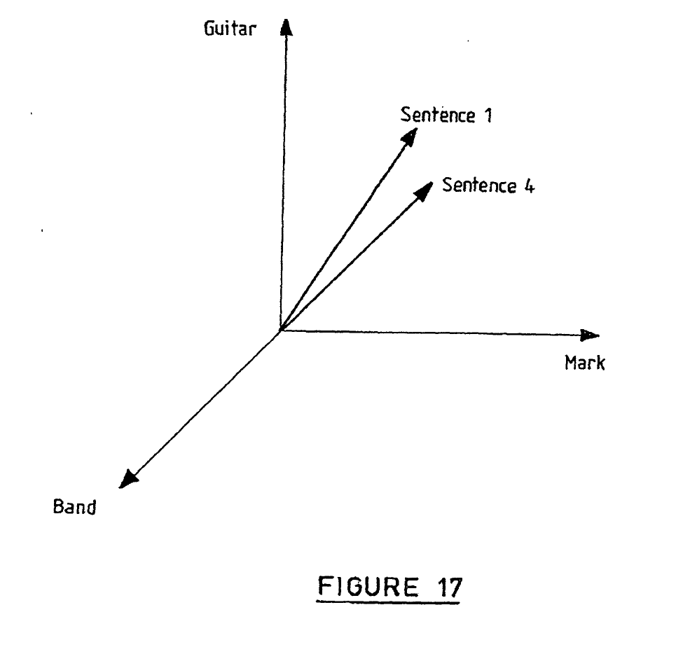

Clustering is a technique which allows segmentation of data. The “n” words used in a document set can be regarded as “n” variables. If a sentence contains a word, the corresponding variable has a value of “1” and if the sentence does not contain the word, the corresponding variable has a value of “0”. The variables build an “n”-dimensional space and the sentences are “n” dimensional vectors in this space. When sentences do not have many words in common, the sentence vectors are situated further away from each other. When sentences do have many words in common, the sentence vectors will be situated close together and a clustering algorithm combines areas where the vectors are close together into clusters. FIG. 17 shows a representation of an “n”-dimensional space.

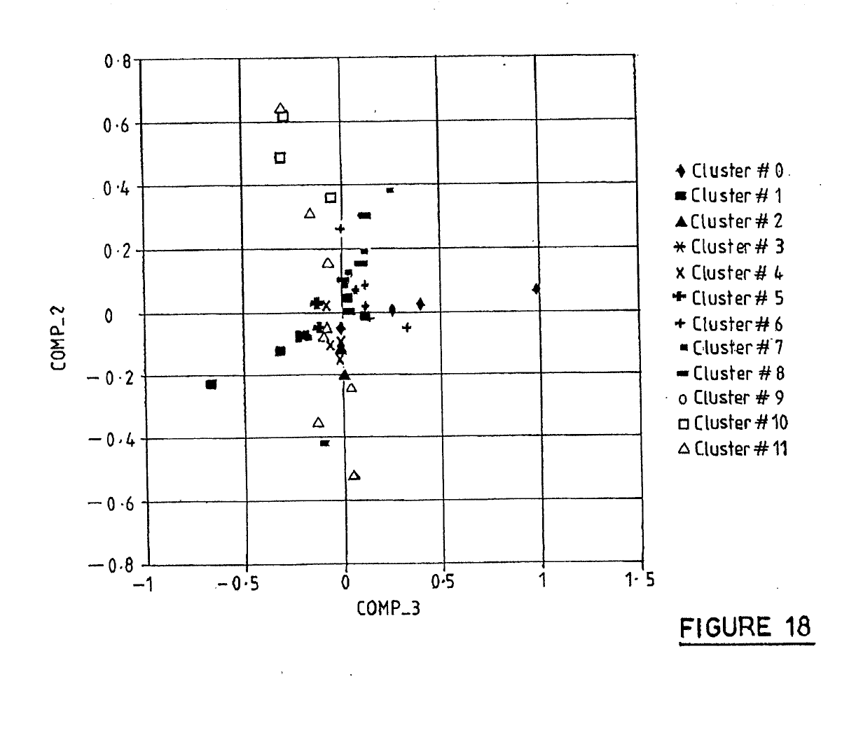

According to the present invention, utilising demographical clustering on a larger document set, in the spherical co-ordinate system, produces the desired linear clusters, which lie along the radii of the “n”-dimensional hyper sphere centred on the origin of the co-ordinate system. Each cluster represents a topic from within the document set. The corresponding sentences (sentence vectors whose endpoints lie within the cluster) describe the topic, with the most descriptive sentences being furthest from the origin of the co-ordinate system. In the preferred implementation, the sentences can be realised by exporting the cluster results to a spreadsheet as shown in FIG. 18, which shows a scatterplot of component 2 against component 1 of the larger document set. In FIG. 18, the clusters now have a linear shape.

Preferably, the components are weighed according to associated information contents. In the preferred implementation, the built in function “field weighting” in the “Intelligent Miner for Text” tool is utilised. Additionally, PCA delivers an attribute called “Proportion”, which shows the degree of information contained in the components. This attribute can be used to weigh the components. Field weighting improves the results further because in the preferred implementation, when the results are plotted, there are no anomalies.

TOPIC SUMMARISATION

According to the present invention, topics are summarised automatically. This is possible by recognising that the sentence vectors with the longest radii are the most descriptive of the topic. This results from the recognition that terms that occur frequently in many topics are represented by term vectors that have a relatively small magnitude and essentially random direction in the transformed co-ordinate frame. Terms that are descriptive of a specific topic have a larger magnitude and correlated terms from the same topic have term vectors that point in a similar direction. Sentence vectors that are most descriptive of a topic are formed from linear combinations of these term vectors and those sentences that have the highest proportion of uniquely descriptive terms will have the largest magnitude.

Preferably, sentences are first ordered ascending by the cluster number and then descending by the length of the sentence-vector. This means the sentences are ranked by their descriptiveness for a topic. Therefore, the “longest” sentence in each cluster is preferably taken as a summarisation for the topic. Preferably, the length of the summary can be adjusted by specifying the number of sentences required and selecting them from a list that is ranked by the length of the sentence vector.

There are numerous applications of the present invention. For example, searching a document using natural language queries and retrieving summarised information relevant to the topic. Current techniques, for example, Internet search engines, return a hit list of documents rather than a summary of the topic of the query.

Another application could be identifying the key topics being discussed in a conversation. For example, when converting voice to text, the present invention could be utilised to identify topics even where the topics being discussed are fragmented within the conversation.

It should be understood that although the preferred embodiment has been described within a networked client-server environment, the present invention could be implemented in any environment. For example, the present invention could be implemented in a stand-alone environment.

It will be apparent from the above description that, by using the techniques of the preferred embodiment, a process for automatically detecting topics across one document or more, and then summarising the topics is provided.

The present invention is preferably embodied as a computer program product for use with a computer system.

Such an implementation may comprise a series of computer readable instructions either fixed on a tangible medium, such as a computer readable media, e.g., diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

Although the present invention and its advantages have been described in detail, it should be understood that various changes, substitutions and alterations can be made herein without departing from the spirit and scope of the invention as defined by the appended claims

We claim:

1. A method of detecting and summarising at least one topic in at least one document of a document set, each document in said document set having a plurality of terms and a plurality of sentences comprising said plurality of terms, wherein said plurality of terms and said plurality of sentences are represented as a plurality of vectors in a two-dimensional space, said method comprising the steps of:
pre-processing said at least one document to extract a plurality of significant terms and to create a plurality of basic terms;
formatting said at least one document and said plurality of basic terms;
reducing said plurality of basic terms;
reducing said plurality of sentences;
creating a matrix of said reduced plurality of basic terms and said reduced plurality of sentences;
utilising said matrix to correlate said plurality of basic terms;
transforming a two-dimensional coordinate associated with each of said correlated plurality of basic terms to an n-dimensional coordinate;
clustering said reduced plurality of sentence vectors in said n-dimensional space; and
associating magnitudes of said reduced plurality of sentence vectors with said at least one topic.

2. A method as claimed in claim 1, wherein said formatting step further comprises producing a file comprising at least one term and an associated location within said at least one document of said at least one term.

3. A method as claimed in claim 2, wherein said creating step further comprises the steps of:
reading said plurality of basic terms into a term vector;
reading said file comprising at least one term into a document vector;
utilising said term vector, said document vector and an associated threshold to reduce said plurality of basic terms;
utilising said extracted plurality of significant terms to reduce said plurality of sentences; and
reading said reduced plurality of sentences into a sentence vector.

4. A method as claimed in claim 1, wherein said correlated plurality of basic terms are transformed to hyper spherical coordinates.

5. A method as claimed in claim 1, wherein end points associated with reduced plurality of sentence vectors lying in close proximity, are clustered.

6. A method as claimed in claim 5, wherein clusters of said plurality of sentence vectors are linearly shaped.

7. A method as claimed in claim 6, wherein each of said clusters represents said at least one topic.

8. A method as claimed in claim 7, wherein field weighting is carried out.

9. A method as claimed in claim 1, wherein a reduced sentence vector having a large associated magnitude, is associated with at least one topic.

10. A system for detecting and summarising at least one topic in at least one document of a document set, each document in said document set having a plurality of terms and a plurality of sentences comprising said plurality of terms, wherein said plurality of terms and said plurality of sentences are represented as a plurality of vectors in a two-dimensional space, said system comprising:
means for pre-processing said at least one document to extract a plurality of significant terms and to create a plurality of basic terms;
means for formatting said at least one document and said plurality of basic terms;
means for reducing said plurality of basic terms;
means for reducing said plurality of sentences;
means for creating a matrix of said reduced plurality of basic terms on said reduced plurality of sentences;
means for utilising said matrix to correlate said plurality of basic terms;
means for transforming a two-dimensional coordinate associated with each of said correlated plurality of basic terms to an n-dimensional co-ordinate;
means for clustering said reduced plurality of sentence vectors in said n-dimensional space; and
means for associating magnitudes of said reduced plurality of sentence vectors with said at least one topic.

11. Computer readable code stored on a computer readable storage medium for detecting and summarising at least one topic in at least one document of a document set, each document in said document set having a plurality of terms and a plurality of sentences comprising said plurality of terms, said computer readable code comprising:
first processes for pre-processing said at least one document to extract a plurality of significant terms and to create a plurality of basic terms;
second processes for formatting said at least one document and said plurality of basic terms;
third processes for reducing said plurality of basic terms;
fourth processes for reducing said plurality of sentences;
fifth processess for creating a matrix of said reduced plurality of basic terms and said reduced plurality of sentences;
sixth processes for utilising said matrix to correlate said plurality of basic terms;
seventh processes for transforming a two-dimensional coordinate associated with each of said correlated plurality of basic terms to an n-dimensional coordinate;
eighth processess for clustering said reduced plurality of sentence vectors in said n-dimensional space; and
ninth processes associating magnitudes of said reduced plurality of sentence vectors with said at least one topic.
